(19) United States
(12) Patent Application Publication
(10) Pub. No.: US 2001/0033344 A1
(43) Pub. Date: Oct. 25, 2001

(54) Virtual reality portrait

(76) Inventors: Darrell Grein, Cypress, TX (US); Chilton Webb, College Station, TX (US)

Correspondence Address: LAW OFFICES OF DAVID MCEWING, 4582 KINGWOOD DRIVE, BOX 118, KINGWOOD, TX, 77345, US

(21) Appl. No.: 09/779,124

(22) Filed: Feb. 7, 2001

Related U.S. Application Data
(60) Provisional application No. 60/180,894, filed on Feb. 7, 2000.

(51) Int. Cl. H04N 5/64; H04N 3/12

(52) U.S. Cl. 348/794; 348/795

(57) ABSTRACT

An apparatus for displaying video images on a flat portable Liquid Crystal Display screen. The apparatus can have audio speakers, and peripheral components such as a clock, radio surge protectors, remote control and input jacks for connecting to a computer. The LCD screen can display recorded digitized images or live feeds. The LCD screen may be located remote from the transmitter providing the video and audio signal. The video and audio signals can be transmitted by wireless means. The signal transmitter can provide signals to multiple remotely located LCD screens and the image and sound can be controlled from a central location.

### CROSS REFERENCE TO RELATED APPLICATION

This application claims the benefit of U.S. Provisional Application No. 60/180,894 entitled “Virtual Reality Portrait” and filed Feb. 7, 2000.

### FIELD OF INVENTION

This invention relates to an apparatus consisting of a flat screen display for projecting a video image, means for receiving remotely transmitted electromagnetic video signals controlling the video image being projected on the screen and audio signals for sound played in speakers housed with the screen display unit or located separately, and a remote projection device housed in a separate unit sending an electromagnetic signal to the signal receiving means contained in or attached to the screen display unit and having means for playing electronically or digitally recorded images and sound. The invention also relates to the apparatus where all components are contained in a single unit or housing containing the flat video screen display, speakers for playing sound, the means for playing recorded images and sound, and the means for playing conventional television signals or cable television signals and sound. The invention also relates to an apparatus that can be mounted on the surface of a wall to display video images or sound. The invention also relates to a device that can be mounted or manufactured into moveable office or living partitions or work surfaces.

### BACKGROUND OF INVENTION

It has become increasingly common for small or enclosed spaces to be occupied and utilized as living spaces or workspaces. This may be due to various factors, including the increasing cost of new construction, desire or need to increase the population of occupants per square foot of work or living space, and desire to recycle existing building structures for new office, light industry or living space. Frequently, this has resulted in some occupants having to spend significant amounts of time in small spaces that provide little or no view outside of the space or immediately adjoining areas. Further, workers may be required to spend considerable amounts of time in small or confined spaces that are monotonous and boring or otherwise unpleasant. In such environments, it has been found that productivity and morale decline. Such environments also are unattractive or undesirable living areas.

It has long been recognized that windows improve the aesthetics of most interior environments. This is readily evident by the large, glass enclosed office tower. It is also evidenced by the large quantity and variety of windows found in most modern homes. It is also suggested that the absence of large occupied underground working and living spaces is due to the absence of windows providing views of the outside, in spite of such underground construction having superior energy efficiency in heating and cooling costs.

Currently, recorded music or radios are used to lessen the boredom or monotony of the work place. Improved and brighten lighting is also used. Brightly colored wall and floor coverings are often used. In addition, to improve the acoustical environment, carpeting and fabric covered office partitions are increasingly used. The increased use of partitions has resulted, however, in the increased isolation and absence of visual stimuli that can make the work environment more pleasant. This has resulted in the expected decrease in productivity and morale. This is seen in the often ridiculed or satirized use of office cubicles, further isolating individuals from the outside world and other workers. Further, crowded and congested living spaces can be unpleasant and stressful.

What is needed is an apparatus that can provide visual, and possibly audio, stimuli suitable for placement in small spaces and with minimal alteration of and intrusion into the interior spaces.

Several efforts have been made in the past to develop a television screen of minimal thickness. The conventional Cathode Ray Tube (CRT) has been modified to reduce the thickness or depth of apparatus. Plasma screens are a recently developed high cost apparatus for creating a flat video display. Other efforts have been directed to the use of Liquid Crystal Display (LCD) screens. An example is the Toshiba Digital Information Display (P400LC/P401LC) consisting of a 40 inch LCD rear projector having a thickness or depth of 15.6 inches and a weight of 75 lbs.

### SUMMARY OF THE INVENTION

One attribute of modern living spaces and work spaces is that they often require occupancy of small spaces or areas that otherwise have no means to see outside, i.e., there is no access to a window. This trend may be expected to continue as the costs of construction continue to increase, the attractiveness of recycling old buildings continues and the efficiency of putting more people in smaller space continues. There is a need for an apparatus that will provide the occupant with a visual and audio distraction that is pleasant, entertaining and relaxing.

Plasma Display screens have recently become available to provide a flat and shallow display screen. Although the surface area of these screens can be large, i.e., in excess of 22 inches measured diagonally, the cost of Plasma screens greatly limits their use in this market.

The present invention is an apparatus that provides a virtual window to the outside or other selected scenes for interior or underground spaces utilizing standard, commercially available components.

The invention also can provide stress relief and therapeutic relaxation. The invention can also be used for educational or recreational purposes. The image can be a real time live video feed of a selected scene. It can also be a recorded scene chosen for its aesthetic characteristics or for promotional or educational presentations.

In describing this invention, the following terms are used:

CD is a commercially available disc system for storing and playing back digital information, including electronically recorded video images and sound. CD-R is a type of disk drive that can create CD-ROMs and audio CD's. This allows users to “master” or “burn” a CD-ROM or audio CD for publishing.

DVD is a commercially available disc system having the capacity to store approximately 20 times the data of a CD. This system can also play electronically recorded video images and sound. DVD-RAM also allows the consumer to erase and record new data on the disc. DVD-RAM is a re-writable compact disc system used in conjunction with the DVD system.

FireWire is a high-speed serial input/output (I/O) for connecting peripherals to a computer and is covered by IEEE standard No. 1394.

Flash Memory cards are commercially available soled state digital memory storage components. Existing applications of these components are in digital cameras and home video game consoles.

LCD is a commercially available electro-optical system used to display digits, characters, or images, commonly used in digital watches, calculators and portable computers. The heart of the liquid crystal display is a piece of liquid crystal material placed between a pair of transparent electrodes. The liquid crystal changes the phase of the light passing through it and this phase change can be controlled by the voltage applied between the electrodes. If such a unit is placed between a pair of plain polarizer plates, light can pass through it only if the correct voltage is applied. Liquid crystal displays are formed by integrating a number of such cells, or more usually, by using a single liquid crystal plate and a pattern of electrodes.

LCD Controller is a commercially available hardware component that transfers digital information from a video card onto a LCD screen. Photo CD is a commercially available system that stores photographic images in a digitized format.

Plasma screen is a commercially available flat panel video display screen that utilizes a neon/xenon gas mixture sandwiched between two sealed glass plates with parallel electrodes deposited on their surfaces. The plates are sealed so that the electrodes form right angles, creating pixels. When voltage pulse passes between two electrodes, the gas breaks down and produces weakly ionized plasma, which emits UV radiation. The UV radiation activates color phosphors and visible light is emitted from each pixel.

Random access memory (RAM) is a component capable of storing large quantities of data that is nearly instantaneously accessible. RAM is an integral component of nearly all CPU's.

Sound Card is a commercially available expansion board that enables a computer to manipulate and output sounds. Sound cards are necessary for nearly all CD-ROMs and have become common on personal computers. Sound cards enable the computer to output sound through speakers connected to the board, to record sound input from a microphone connected to the computer, and to manipulate sound stored on a disc.

USB is a Universal Serial Bus that supports data transfer rates of 12 MBPS (12 million bits per second). A single USB port can be used to connect up to 127 peripheral devices, such as mice, modems, and keyboards. USB also supports Plug-and-Play installation and hot plugging.

Video Card is a commercially available board that plugs into a personal computer to give the computer display capabilities. The display capabilities of computer, however depend on both the logical circuitry (provided in the video adapter) and the display monitor. A monochrome monitor, for example, can not display colors no matter how powerful the video adapter.

In one preferred embodiment of the invention, a single LCD display screen and a power supply is combined with other components, such as a CPU, audio CD player, photo CD unit, speakers, radio, and sleep timers, in a self contained unit or housing to display the desired image. In another embodiment, this image is transmitted to a remotely located LCD screen, without wires, from a separately housed power supply and CPU, CD, CVD or VCR player by digitized electromagnetic signals.

Prior to this invention, LCD screens, typically utilized in laptop computers, were not readily suitable for the display of video image for several reasons.

First, LCD screens were not large enough for anything other than palm-sized television screens. They were costly to manufacture, and difficult to view. In the past few years, numerous advances in flat panel display technology have created LCD screens that are much larger, brighter, easier to view, and which cost much less than comparable screens introduced just a year earlier.

Second, circuitry that allowed a VGA device such as a LCD screen or CRT monitor to display NTSC or PAL composite video were relegated to video cards for computers. They were not commercially available for devices that weren't connected to computers.

Third, the wireless technology necessary to transmit video was too costly to effectively be used in the video industry, and without the aforementioned VGA converter, the signal which would have been transmitted would have exceeded the bandwidth that wireless communications can easily transmit.

As a result of these simultaneous advances in separate technologies, it is now possible to utilize a combination of commercially available components to create a flat LCD display device capable of video and sound display. The LCD display screen and speakers may be housed separately from other components of the apparatus, i.e., VCR, DVD player, television receiver, etc. and receive the video and sound signals via remote and wireless systems. Alternatively, the LCD display apparatus may be housed completely in a single unit.

Advantageously, the invention, hereafter termed the Virtual Reality Portrait or VR Portrait, is manufactured of components that allow a flat screen to be portably and temporarily mounted to the surface of a wall using conventional hardware. The flatness of the screen and absence of depth or thickness to the screen and screen structure or screen housing allows the VR Portrait to be placed on the wall without cutting into the wall or requiring the screen to protrude significantly into the interior living or work space. The VR Portrait housing may be less than 4 inches in depth and extend to the width and height of the LCD display screen, audio speakers and other components such as a separate, small LCD display screen for time and control display. The height and width of the VR Portrait LCD display screen unit may be in a range of 36 by 36 inches and 5 by 5 inches. The VR Portrait LCD display screen unit may weigh between 20 and 2 lbs. The depth or thickness of the LCD display screen unit may be in a range of less than 2 to 4 inches.

In one preferred embodiment, a separately located transmitter and controller provides the transmission of the electromagnetic signal for the electronic image to be displayed on the screen. One advantage of the controller, and transmitter being located separately from the screen is that it can simultaneously operate several separately located LCD display screen units. This can allow a central location to control the video image or sound received by persons in separate areas. Another advantage is that the separate, centralized control can be used for education or used in medical or psychiatric treatment.

In another embodiment, the VR Portrait is used to display a real time view. A real time view is the simultaneous recording, transmission and display of a live event so the image displayed on the screen is of activities or events as they occur. This application may be used for security or surveillance purposes due to the superior resolution of the video image compared to commonly used CRT's of similar size. This real time viewing display can also be used for use in promoting or selling remote properties or other objects where actual visits are not practicable due to distance, cost, hazard or the desire to have multiple parties in differing location view the same object or objects.

The real time view display can also be used for aesthetic purposes. For example, larger modem office complexes often have an atrium, entry way or an exterior area where particular emphasis has been placed on the design, construction and maintenance of the area for the ascetic enjoyment or for the establishment or identification of a company or business image. Although photos may have been used in the past to display this area at other locations places of the workspace or at other business locations, the VR Portrait will allow a much more effective or interesting presentation. It is a goal that this utilization of the VR Portrait will enhance a feeling of employee participation by having access, via the VR Portrait, to a space or image specifically designed to evoke a particular impression in the viewer. This can, for example, be a large image of an impressive building lobby, fountain, or garden space or building entrance landscaping. It can also be used for office or company communications or announcements.

In another embodiment of the VR Portrait, it provides the utility of a home entertainment center, replacing a television with a CRT picture tube, cable box, DVD player, a CD player, computer, modem and speakers, with a single unit that has those capabilities plus provides ambient decoration. It utilizes less electricity than those devices used together and a decorative function when it is not employed for entertainment, i.e., television, Internet or video games. This decorative function is achieved by a recorded scene, selected for it aesthetic proportion being displayed on the VR Portrait.

### BRIEF DESCRIPTION OF THE DRAWINGS

FIG. 1 depicts a schematic view of the principal components of one embodiment of the present invention wherein the LCD screen is separate and wirelessly connected to the video and audio playing devices. It is noted that the drawing illustrates only one embodiment of the invention and is therefore not to be considered limiting of its scope, for the invention will admit to other equally effective embodiments.

### DETAILED DESCRIPTION OF THE INVENTION

The VR Portrait can be operated in several alternative embodiments, depending upon the peripheral devices incorporated in the VR Portrait, the means of transmitting the signal from the player to the LCD display screen (whether by wires or electo-magnetic signal) or whether all components are incorporated into a single housed unit or separate housings. The most simple and least costly embodiment utilizes an LCD display screen in a single housing containing all peripherals, including a power supply. This embodiment of the VR Portrait utilizes an LCD display screen of a type manufactured by Samsung, TG or other commercially available LCD display screens. It also utilizes a LCD Controller comprising a controller board, video signal processor, a backlight and interface card for a Peripheral Component Interface (PCI) based computer. Suitable interface cards include Earth Computers 12.1 inch SVGA, part number 2002. The LCD Controller will be contained in the apparatus housing. A plurality of commercially available audio speakers designed with minimal depth, described commercially as flat speakers, is also contained in the apparatus housing.

The VR Portrait can also include an infra-red motion sensor, remote video display unit, a power supply, a FireWire port, a USB port, a surge protector, a radio, composite RCA and digital VGA ports located on the housing for connecting the VR Portrait to conventional television and cable TV signals, computer mouse, remote controller and a timer. The timer can include a separate and smaller LCD panel. The timer can have the capacity to control the on-off function of the unit or individual peripheral devices.

Other variations of the VR Portrait can include a DVD player. Other variations of the VR Portrait can include changeable frames to allow the VR Portrait display screen to be adapted to various decors. These decorative frames can be permanent or be capable of being removed or replaced with alternate frames differing in color, texture or shape, as may be deemed appropriate by the user for the surrounding decor of the work or living environment. This embodiment may be especially desirable with the wireless remote LCD display screen separate from the other components of the apparatus.

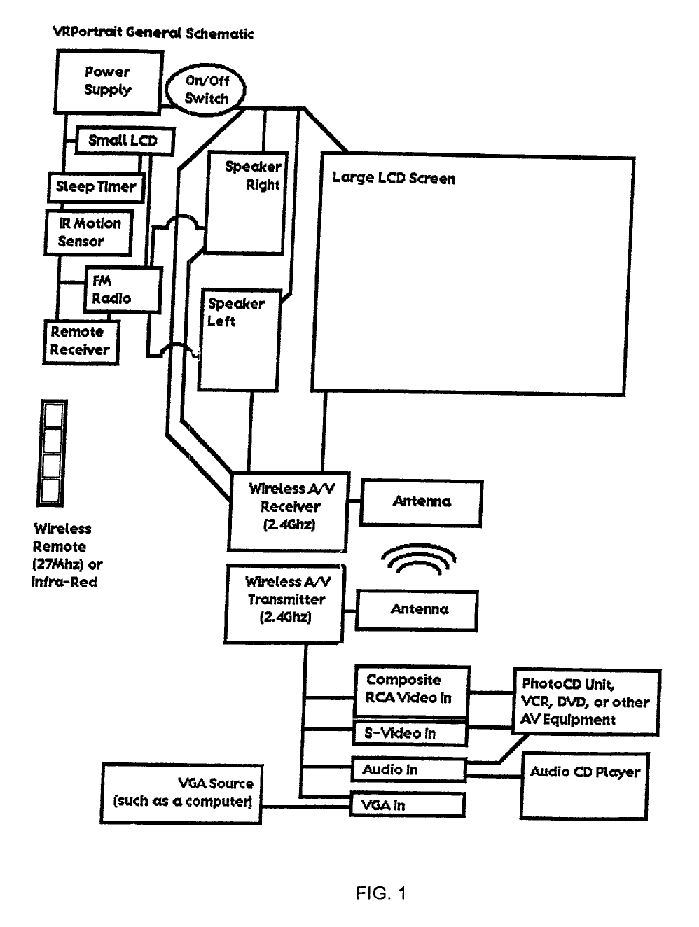

FIG. 1. illustrates a schematic drawing of the VR Portrait. The VR Portrait can function as a monitor for a computer, a display screen for a VCR or other audio-visual equipment, or an ambient or background multimedia display of sounds and images. It can be held by the user, used as a stand-alone apparatus (with an optional stand) or be mounted on a wall. Its weight will be substantially less than conventional televisions and minimal hardware will be required to attach the VR Portrait to a wall. No cutting into the wall or other structural modification will be required. This ease in which the VR Portrait can be installed will facilitate its utility by allowing it to be moved from location to location with minimal effort and time. Its weight will also be substantially less than a conventional CRT Computer screen. This will permit the screen to be held in the user's hands for greater ease and comfort for reading of text, etc.

The VR Portrait can also be preinstalled into a manufactured office or living space wall partitions. In another embodiment, the VR Portrait may be installed into a horizontal work surface. In a further embodiment, the horizontally installed VR Portrait is installed with means to pivotally adjust the VR Portrait to a vertical position as desired by the user to facilitate ease of viewing and use. When not in use, the VR Portrait can fold flush with the top of the horizontal work service to increase the efficient use of work or living space. In another embodiment in which the LCD display screen is housed separately from the other components, the LCD screen, alone or with a plurality of audio speakers, may also be installed into the manufactured wall or work surface.

The VR Portrait may also utilize one or more LCD screens. The LCD screens may be located in separate area but controlled from a single source. Individual screens can be moved to different locations as may be desired. The screens will not require wiring to be installed since only a power source is required for operation. Alternatively, the screens may be placed in proximity to another to allow a single image to be displayed. In this application, each screen will display part of the larger image. In another application, the screens may each display separate images or form parts of changing geometric patterns or other aesthetically chosen schemes.

One application of the VR Portrait will be to allow the user to awaken to the sounds and scenery of a waterfall, forest, or any of a variety of sounds and pictures contained on pre-recorded disks or tape. In this application, the VR Portrait would be time to turn on a programmed by the internal clock. Utilization of the optional DVD unit will include full motion DVD displays of similar scenes, but with the added benefit of having motion to the scene. The DVD unit allows the VR Portrait to display actual movies.

Video from external sources can be played on the VR Portrait via standard and commercially available video and phono connectors located on the exterior of the unit. In the preferred embodiment, these connectors are located in a suitable accessible location, such as the side of the apparatus housing to allow convenient utilization without removing the apparatus from the wall mounting or interference with the VR Portrait frame. The VR Portrait will also incorporate connectors for standard VGA or SGVA ports, video in (a phono port), video out (a phono port) and audio in and out (two sets of right and left phono ports). This will allow the computer user to use the screen as their display unit. Either command from the computer unit or a switch located on the VR Portrait housing can perform switching back and forth between external and internal audio and video sources.

An optional wireless remote transmitter and receiver maybe utilized to transmit video directly to the VR Portrait from up to 100 yards away, even through walls.

The VR Portrait can also operate as a single image slide-show unit or, with a digital camera, be used for security, surveillance or aesthetic purposes. The VR Portrait can function as a single ambient sound and video source, much like a real window. For example, a window allows a person to have a view of scenes outside of the interior wall. It also can facilitate the transmission of sound between the interior and exterior. The VR Portrait also allows scenery outside of the interior wall to be displayed. It can also transmit the sounds heard in the outside.

Other applications of the VR Portrait include the presentation of pictures or videos for commercial sales promotions, or displays of individual and family pictures and movies or other desired scenes or images when the unit is not otherwise being utilized. This default application, similar to the role used by a computer monitor screen saver, would utilize a photo CD player.

Other applications of the VR Portrait include the display of multimedia advertising on the walls of stores, hotels, airports, etc. It can also be used in conjunction with a video camera and the optional wireless audio-video equipment to function as an excellent security or remote surveillance system. The VR Portrait can be also used in conjunction with AC/DC electrical adapters to operate within buses or other transportation systems to display information or advertising. This could include the display of airline flight times and gate locations inside airport shuttle buses. It could also be utilized to facilitate the equipment operator's view of the area around the equipment. For example, to provide the bus or truck operator a view of the rear of the bus or truck when the operator is backing up the unit. It can also be used to facilitate the operation of equipment from distant locations. For example, to assist a crane operator see the end of the crane hoist when extended away from the operator's control station. The VR Portrait can also be used to display information, including video pictures, of the restaurant entrees, daily menus or desserts. This would allow the menu items to be conveniently updated and revised daily by the entry of the information at a single location. Further, the display of the menu can increase the accuracy and speed the consumer ordering process with resulting savings of time and cost. Record stores could use the VR Portrait to display pictures of the recording artist simultaneously while playing the artist's music. Product and service providers could display pictures or movies of their products and services with audio sales presentations. Museum and art galleries could display maps and updated information, e.g., exhibit wait times or schedules of future exhibits.

The range area of the LCD display screens is typically between 6 inches and 22 inches measured diagonally. The VR Portrait is less expensive and displays a higher resolution image than a plasma screen display of the same size. The VR Portrait incorporates commercially available components. Radio Shack LCD display screens, model DPM31L, DPM31RA, and DPM33R, are examples of units that can be satisfactorily utilized.

It will be appreciated that the dimensions provided within the specification are for illustration only and are not to be read as limitations on the invention.

Remote signal transmitter and receivers manufactured by Radio Shack model 980-0659 and 980-0660 and 15-1971 can be satisfactorily utilized.

The invention can also be utilized as a self-contained unit incorporating a large flat LCD display screen, CPU, CD, CVD or VCR player and speakers.

The Invention can also be utilized in conjunction with one or more random access memory components for playing of recorded messages, video images or sound. This mode of operation can be independent of a remote signal transmitter, thereby reducing power consumption or allowing use of the VR Portrait during times that a remote signal can not be received or that the remote signal transmitter is not available. In addition, the invention may also be used in connection with one or more Flash Memory cards. This component allows interchange of cards containing stored digital electronic data. It allows the quantity of recorded programming to be independent of the RAM capacity of the device. Both RAM and Flash Memory cards facilitate the portablility of the VR Portrait by allowing the invention to be utilized at locations independent of or remote from a signal transmitter device.

The VR Portrait can also used in conjunction with batteries that would allow the apparatus to operate for brief periods of time without an external power source. Preferably, the batteries would be rechargeable without being removed from the apparatus after the external power source is again available.

In the preferred embodiment, the controls, power switch and computer ports are located at a the side or other location on the apparatus housing so that the external components can be quickly and easily connected and removed without requiring the apparatus to be removed from the wall or stand. The placement of these controls and ports may also be adapted for compatibility with the interchangeable display screen frames.

In a further embodiment of the invention, the VR Portrait contains a computer within the apparatus housing. In another preferred embodiment of the invention, the computer needs to have the capacity of a Pentium class computer chip, manufactured by Intel Corporation, or a PowerPC computer chip, manufactured by IBM and Motorola, and possessing 64 Mb of RAM, 10 Gb of hard drive space, running the MacOS, Windows98 or WindowsNT, the BeOS, Linux, OSX, or a variation of the Unix operating system. Optionally, a PCI extender of a type manufactured by Magmaor similar may be used to increase the resolution across multiple screens by providing one separate video card for each display. The computer should support and control the Photo CD and DVD player.

The foregoing description is illustrative and explanatory of preferred embodiments of the invention and variations in the size, shape, materials and other details will become apparent to those skilled in the art. It is intended that all such variations and modifications which fall within the scope or spirit of the appended claims be embraced thereby.

What is claimed is:

1. A Video display apparatus comprising:
a. at least one LCD display screen;
b. at least one audio speaker;
c. at least one electrical power supply;
d. at least one means for playing recorded electronic video images;
e. at least one means for playing audio signals; and
f. at least one means for controlling functions of the apparatus.

2. The invention of claim 1 wherein the at least one means for controlling the functions of the apparatus comprise a remote wireless device.

3. The invention of claim 2 wherein at least one remote wireless control device utilizes infra-red signals

4. The invention subject of claim 1 wherein at least one LCD display screen is mounted in a manner comprising part of a substantially horizontal surface.

5. The invention of claim 1 wherein at least one LCD display screen is mounted in a substantially vertical orientation.

6. The invention subject of claim 1 wherein at least one LCD display screen is mounted in a moveable wall or office partition.

7. The invention of claim 6 wherein at least one audio speaker is mounted in a moveable wall or office partition.

8. The invention of claim 1 wherein the video and audio signals are played by digital electronic means.

9. The invention of claims 1 additionally comprising a radio, clock timer controlling the on/off function of the video or sound display and means for displaying the time, radio frequency, video or sound channel, or alarm setting.

10. The invention of claim 1 wherein the means for playing the video signal and audio signals are located separately from the LCD display screen

11. The invention subject of claim 10 wherein at least one LCD display screen is mounted in a manner comprising part of a substantially horizontal surface.

12. The invention subject of claim 10 wherein the LCD display screen is mounted in a substantially vertical orientation.

11. The invention subject of claim 10 wherein the LCD display screen is mounted in a moveable wall or office partition.

12. The invention of claim 11 wherein at least one audio speaker is mounted in the moveable wall or office partition.

13. The invention of claim 10 wherein the means for playing the audio or video signal comprises at least on of a group consisting of a VCR, DVD and CD player.

14. The invention of claim 10 wherein the means for playing the audio or video signal comprises at least one random access memory component.

15. The invention of claim 10 wherein the means for playing the audio or video signal comprises at least one Flash Memory cards.

16. The invention of claim 10 wherein the video signal and audio signals are conveyed to the LCD display screen and speakers by means of wireless transmission and reception of electromagnetic signals or digitized signals

17. The invention of claim 16 wherein the video signal and audio signals are conveyed to the LCD display screen and speakers by means of wireless transmission and reception of electromagnetic signals or digitized signals and the means for playing the audio or video signal comprise at least one of a group consisting of DVD players, CD players, random access memory components and Flash Memory cards.

18. The invention subject of claim 16 wherein the LCD display screen is mounted in a manner comprising part of a substantially horizontal surface.

19. The invention subject of claim 16 wherein the LCD display screen is mounted in a substantially vertical orientation.

20. The invention subject of claim 16 wherein the LCD display screen is mounted in a moveable wall or office partition.

21. The invention of claim 20 wherein at least one audio speaker is mounted in the moveable wall or office partition.

22. The invention of claim 16 or 17 additionally comprising a radio, clock timer controlling the on/off function of the video or sound display and means for displaying the time, radio frequency, signal channel sound channel, or alarm setting.

23. The invention of claim 16 wherein the video signal and audio signals are conveyed to the LCD display screen and speakers by means of wireless transmission and reception of digitized signals and the means for playing the audio or video signal comprise at least one DVD player.

24. The invention of claim 16 wherein the video signal and audio signals are conveyed to the LCD display screen and speakers by means of wireless transmission and reception of digitized signals and the means for playing the audio or video signal comprise at least one CD player.

25. The invention of claim 16 wherein the video signal and audio signals are conveyed to the LCD display screen and speakers by means of wireless transmission and reception of digitized signals and the means for playing the audio or video signal comprise at least random access memory component.

26. The invention of claim 16 wherein the video signal and audio signals are conveyed to the LCD display screen and speakers by means of wireless transmission and reception of digitized signals and the means for playing the audio or video signal comprise at least one Flash Memory card.

27. The invention subject of claim 16 wherein
a. at least one LCD display screen and speaker are mounted in a substantially vertical surface;
b. the video signal and audio signals are conveyed to the LCD display screen and speakers by means of wireless transmission and reception of digitized signals; and
c. the means for playing the audio or video signal comprise at least one of a group consisting of Flash Memory card, random access memory component, VCR, DVD player and CD player.

28. The invention of claim 27 wherein at least one of the LCD display screens and speaker is located in a movable wall or office partition.

29. The invention of claim 27 or 28 wherein at least one signal control means is located remote from at least one LCD display screen.
